(19) United States
(12) Patent Application Publication
(10) Pub. No.: US 2015/0090946 A1
(43) Pub. Date: Apr. 2, 2015

(54) VARIABLE SPEED CHAIN HOIST WITH INTEGRATED CONTROL

(71) Applicant: Barry M. Schwaiger, Murfreesboro, TN (US)

(72) Inventor: Barry M. Schwaiger, Murfreesboro, TN (US)

(73) Assignee: JPW Industries Inc., LaVergne, TN (US)

(21) Appl. No.: 14/503,946

(22) Filed: Oct. 1, 2014

Related U.S. Application Data
(60) Provisional application No. 61/885,312, filed on Oct. 1, 2013.

(51) Int. Cl. B66D 3/26; B66D 3/20; B66D 1/12; B66D 1/46

(52) U.S. Cl. CPC B66D 3/26; B66D 1/46; B66D 3/20; B66D 1/12
USPC 254/362

(57) ABSTRACT

A variable speed chain hoist has the variable speed control integrated into the housing of the chain hoist and a user control for varying the speed of the hoist that is integrated into the pendant controller. The speed control may include an inverter connected to the motor of the hoist. The user speed control may include a rotary knob or a slider connected to a potentiometer and integrated into the pendant control to vary a voltage signal supplied to the inverter.

### CROSS-REFERENCE TO RELATED APPLICATION

The present application claims the benefit of U.S. Provisional Patent Application Ser. No. 61/885,312, filed Oct. 1, 2013, which is incorporated herein by reference.

### BACKGROUND OF THE INVENTION

1. Field of the Invention

The present invention relates generally to a hoist, and more particularly to hoist with a variable speed operation.

2. Description of the Related Art

When materials or items need to be lifted or lowered, or items need to be brought closer together, a hoist is a tool that is often used to perform the job. Hoists are provided as either manually operated (hand powered) or powered by a motor or other drive to provide the motive force for operating the hoist. The motor or drive may be hydraulic, pneumatic, or electric, or may use a fuel such as gasoline to power the motor. Hoists are classified by the lifting medium used in the hoist. For example, hoists may use a rope, a wire rope or cable, or a chain. The lifting medium may be wrapped around a drum or may be feed through a block.

Electric powered hoists made today, and particularly those that use chain as the lifting medium, are provided as single speed drive or two speed drive. An operator is provided with a control, such as a pendant control box connected to a control cable that extends from the hoist housing, that has an on-and-off control and may have a switch to permit switching between two operating speeds.

### SUMMARY OF THE INVENTION

The present invention provides a hoist, such as a chain hoist, with a variable speed control for lifting and lowering a load or for bringing objects together. The variable speed control is integrated into the hoist housing with the drive motor. The user control of the variable speed drive is integrated into the pendant controller.

### BRIEF DESCRIPTION OF THE DRAWINGS

FIG. 1 is an perspective view of a prior art chain hoist and pendant controller;

FIG. 2 is a perspective view of a chain hoist housing of a variable speed chain hoist according to the principles of the present invention;

FIG. 3 is an exploded view of the chain hoist housing of FIG. 1;

FIG. 4 is an exploded view of the chain hoist with a speed regulating portion shown in detail;

FIG. 5 is a top plan view of a pendant controller for the variable speed chain hoist;

FIG. 6 is a cut away view of the chain hoist; and

FIG. 7 is a functional block diagram of the motor control.

### DETAILED DESCRIPTION OF THE PREFERRED EMBODIMENTS

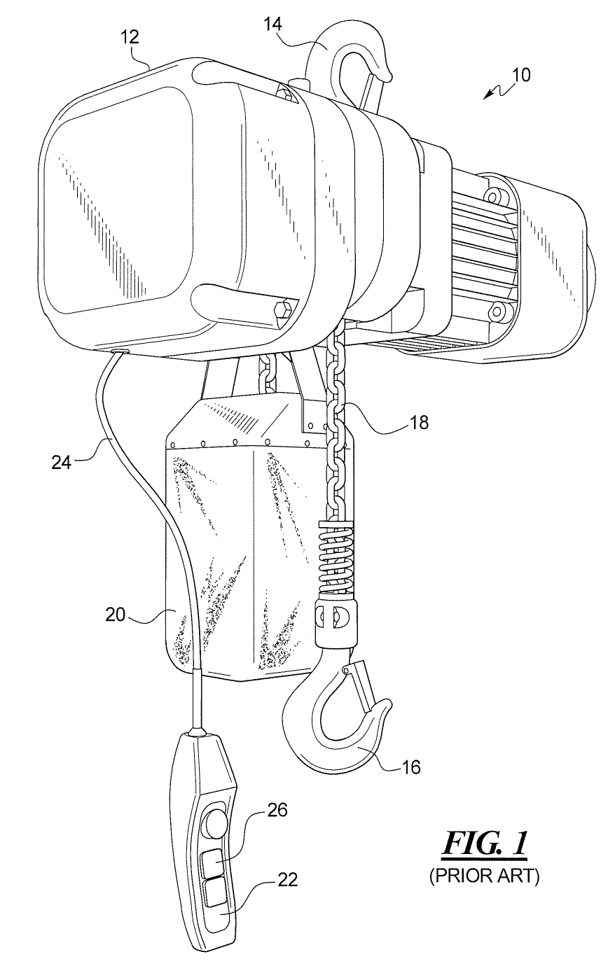

A prior art chain hoist 10 is shown in FIG. 1. The chain hoist 10 includes a housing 12 that encloses a motor, a chain drive, control electronics, and potentially other components. The housing 10 is suspended by a hook 14 from a support and a load is affixed to a load hook 16 that is supported below the housing 12 by a chain 18. Chain engaging elements within the housing 12 operate under the power of the motor to retrieve chain into the housing 12 or let chain out of the housing 12 so that the load is raised or lowered. The end of the chain 18 opposite the load hook 16 is held in a chain holding bag 20 after the chain has passed through the housing 12. A pendant controller 22 is connected to the housing 12 by a cable 24. The pendant controller has two buttons 26, a first of which is operated to lift the load and a second of which is operated by a user to lower the load. The chain hoist 10 has a single operating speed.

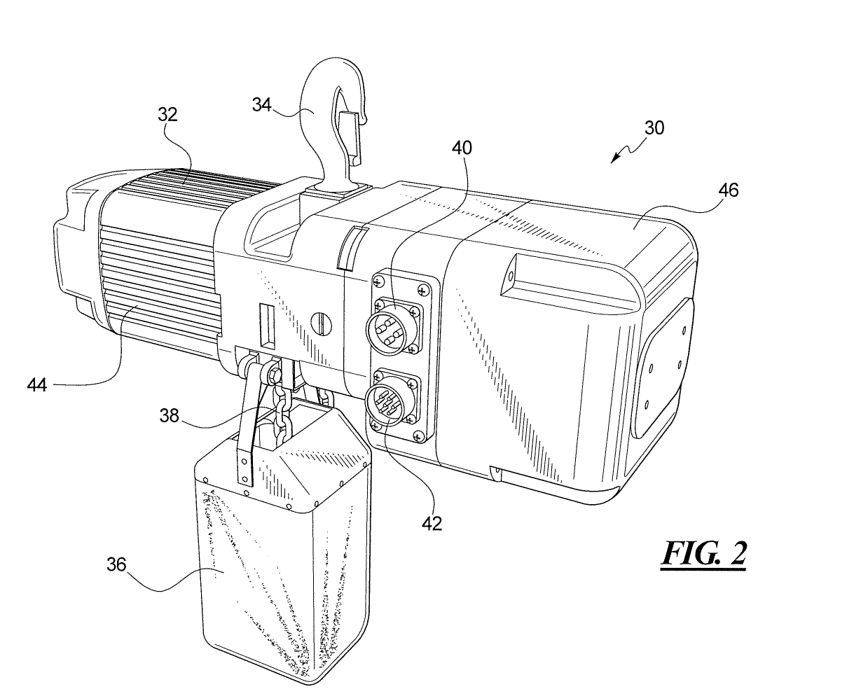

Referring to FIG. 2, a hoist, such as a chain hoist or hoist using another lifting medium, with an integrated variable speed control 30 has a housing 32, a hook 34 by which the housing 32 is suspended from a support, and a chain collecting bag 36 into which a chain 38 extends from the housing 32. Other suspension means for supporting the housing from a support are of course possible in alternate embodiments. Other lifting media may be used in place of the chain 38, which may require changes to the lifting medium engaging elements, such as use of a drum or other lifting medium engagement means, as is known. The housing 32 encloses a motor, chain drive and motor control circuit. The chain 38 passes through the housing 32 as it extends from the chain collecting bag 36 to the load engaging hook (behind the bag 36 in this view). As the hoist 30 is operated to lower the load, links of the chain 38 are drawn from the bag 36, pass through the chain opening into the housing 32 where the links of the chain 38 are engaged by a chain wheel, and are fed out of the chain opening as the load moves downward. A single chain opening may be provided for both portions of the chain, or two chain openings may be provided, one for the load end and the other opening for the chain end to be captured in the chain holding bag. Operating the hoist 30 to raise the load results in links of the chain 38 being drawn into the housing 32, passing around the chain wheel and moving out of the housing 32, where the chain links accumulate in the bag 36.

Connectors 40 and 42 are provided on the housing 32. The connector 40 is connected to a power cord that is in turn connected to line power to supply electrical power to the hoist 30. The electrical power may be single phase power or three phase power, for example. The connector 42 of the illustrated embodiment is a multi-pin connector that is connected to a cable of a pendant controller. The connector 42 has sufficient number of electrical connection pins to transmit variable speed control signals to the motor control circuit within the housing 12, as well as to transmit direction signals, on/off signals, etc.

A motor is provided within a slotted portion 44 of the housing. The motor and motor control circuit are connected to an inverter that permits lifting and lowering of a load by the hoist at varying speeds. The inverter is enclosed within the housing portion 46 at the end of the housing 32 opposite the motor. The control circuit and inverter that are integrated within the housing 32 permit variable speed control of the chain wheel so that the chain may be moved at different speeds, and preferably a large number of different speeds, as the load is lifted or lowered.

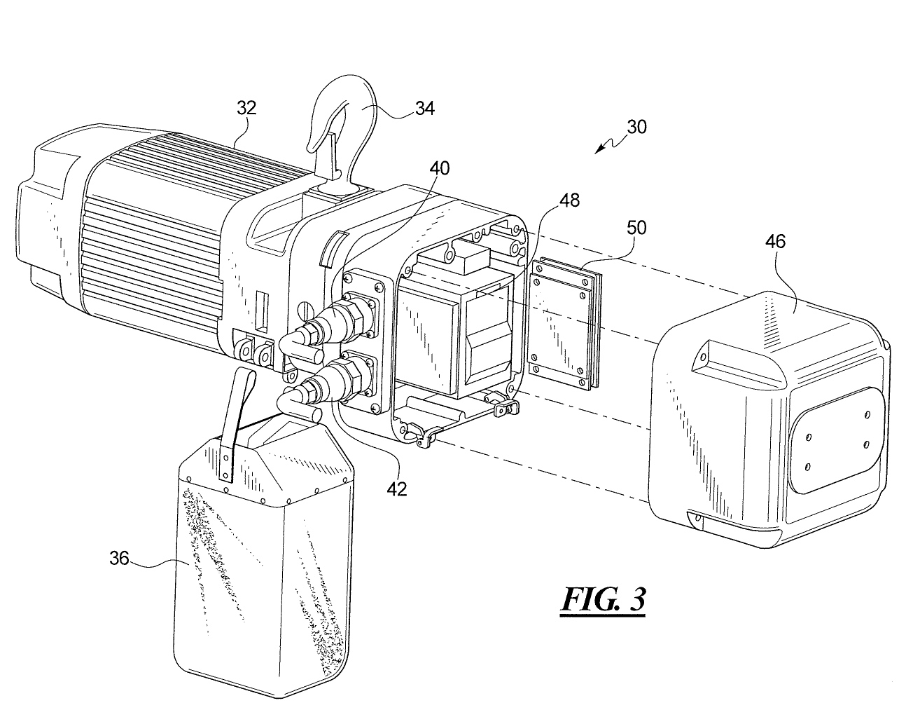

In FIG. 3, the housing 32 has been opened to reveal an inverter 48 within the housing portion 46. The inverter 46 is enclosed within the housing 32 and connected into the motor control circuit which permits the motor and chain drive to operate at a wide range of operating speeds. The range can be either continuously variable or can be varied in increments within the speed range. A cover 50 is provided on the inverter 48. The cover 50 is shown removed from the inverter in this view.

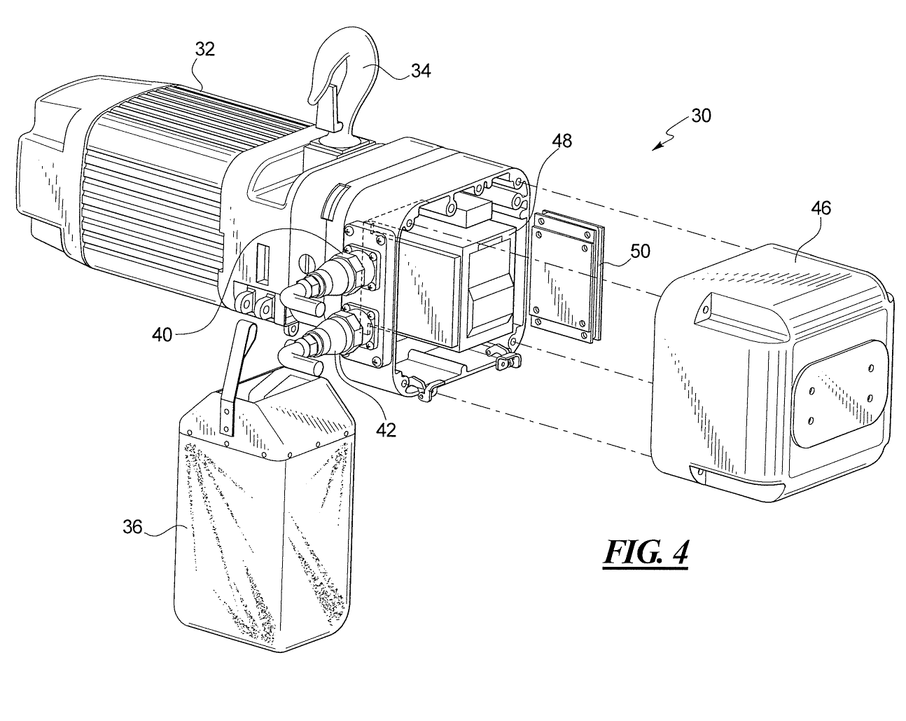

In FIG. 4, the inverter 48 extends into the housing 32 and is connected into the motor control circuit within the chain hoist 30. The inverter 48 is a self-contained unit that is mounted within the housing 32. In an example of the variable speed hoist, the inverter is a Hitachi WJ200 AC Variable Speed Drive industrial inverter that may have a single phase or three phase input to a three phase output and provides high starting torque and speed stability. The inverter is connected to the hoist motor, such as a permanent magnet motor or an induction motor. The motor of a preferred embodiment is a three phase motor. Of course, other speed control elements and circuits and devices may be provided instead.

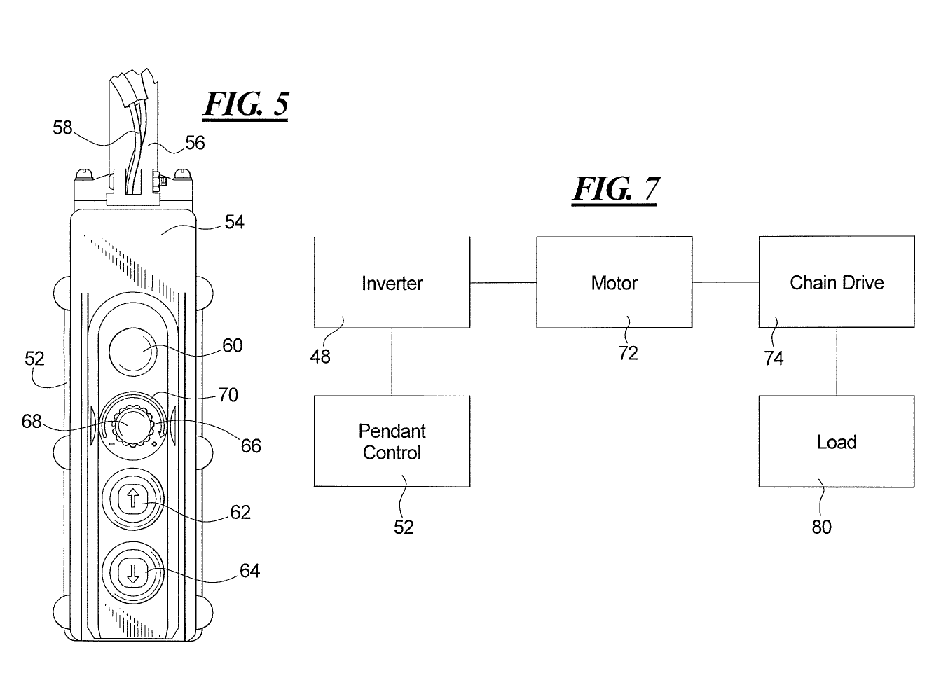

With reference to FIG. 5, a pendant controller 52 is provided within a housing 54 that is connected to a cable 56. The cable 56 is connectable to the connector 42 of the hoist 30 to provide electrical communications between the pendant controller 52 and the motor control circuit within the hoist housing 32. The pendant controller 52 may also include a suspension cable 58 that supports the weight of the pendant controller 52 and avoids excessive tension on the electrical cable 56.

The pendant controller 52 has an on/off button 60 that is pressed by a user to start the hoist operation and released to halt operation. The user may press and hold the button 60 for extended operation or briefly press the button 60 to move the load a short time. Direction control buttons 62 and 64 are pressed by the user to switch the operation of the hoist from a lifting operation to a lowering operation, or vice versa. Included in the pendant controller housing 54 along with the other controls is a variable speed dial 66. The variable speed dial 66 includes a rotatable knob 68 that is twisted by the user to change the operating speed of the hoist over a continuous or near continuous range of operating speeds. The rotatable knob 68 operates a potentiometer within the pendant housing 54 to vary a voltage of a speed control signal. A potentiometer and a resistor are connected in the control circuit, as will be understood by those of skill in the art. In one example, the voltage output by the potentiometer is within a range of zero to 10 volts. The potentiometer output is connected to the control input of the inverter.

The rotatable knob 68 is provided as an integrated element in the pendant housing 54 of the pendant controller. An indicator dial 70 is provided at the rotatable knob 68 to provide an indication to the user of a rotation direction to increase the speed of the hoist operation and to decrease the speed of the hoist operation. The indicator dial 70 may be an overlay as shown or may be embossed, painted, engraved or otherwise marked on the housing 54. The rotatable dial 70 is one option for controlling the speed of the lifting and lowering operation. Other options within the scope of the invention include a slider, joystick, trigger, pressure sensitive controller or other controller that provides a variable output signal and may be used to select from a plurality of speeds for hoist operation. Yet other options within the scope of this invention include a digital speed selector with a control that enables the user to select one of a plurality of speeds and a display that indicates the speed that has been selected such as by a numerical indication. Other speed selectors are possible as well.

The variable speed control circuit and the variable speed controller are formed as an integrated element of the chain hoist in the housing 32 and the pendant controller 52 of the hoist.

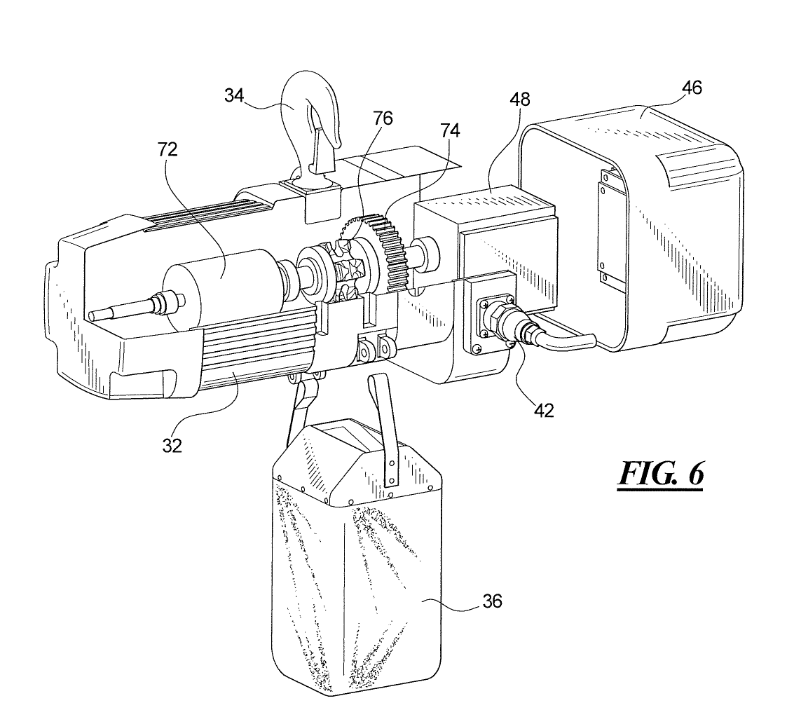

Turning to FIG. 6, the housing 32 encloses the motor 72, which has an output connected to a gear drive 74. The gear drive 74 transfers rotary motion of the motor 72 to a chain wheel 76 that moves the chain at varying speeds through the housing 32. Other transmission constructions and types are possible and are within the scope of this invention. Similarly, other chain engaging means are possible. It is also envisioned that the hoist may be a cable hoist or other type of hoist. The connection 42 to the pendant controller 52 with the variable speed control 66 is shown on the housing 32. The inverter and variable speed motor control 48 is within the housing 32 under the cover 46.

A user may operate the variable speed controller on the pendant controller to lower a load at a higher speed until the load is near a load landing site. The user may dial back the speed of the hoist using the rotary controller or other controller to slow the lowering speed of the load. A load that is fragile, for example, may be deposited at the load landing site with little or no impact at the landing surface. A load may be handled gently by varying the speed of the hoist in both the lowering and the lifting directions. Delicate items may be moved by the present hoist, even if the items are heavy.

In FIG. 7, the pendant control 52 provides a user interface for controlling the on and off operation of the hoist, the direction of operation, and for selecting a variable operating speed. In one embodiment, the pendant control 52 generates a speed control signal that varies within a range of zero to 10 volts. The pendant control 52 is connected to the inverter 48 to receive the variable speed signal. The inverter 48 is connected to the motor 72 to control the operating speed of the motor. The inverter 48 varies the frequency of the output signal, such as a sine wave, to change the operating speed of the motor. The frequency is changed within the operating range of the motor. The inverter 48 provides a correlation between the variable voltage level output by the potentiometer of the pendant control and the frequency of the motor control signal. Other speed control means are also possible. The chain drive 74 engages a chain that holds, lifts or lowers a load 80.

In an alternate embodiment, the motor control signal, including the motor speed control signal, may be provided by a remote source. For example, the hoist may be controlled by a user at a relatively great distance from the hoist device. The control signal may be transmitted via a length of cable or other remote system. Control signals may be transmitted via a wired or wireless connection and may be provided to control the hoist via a computer system including via a network connection, such as a LAN, WAN or the internet. The control signals may require translation from one format to another to facilitate the long distance transmission of the signal. For instance, a digital signal representing the control voltage may be transmitted via digital communication means and converted to the control voltage for input to the inverter, in one example. The pendant control is therefore replaced by the more distant remote control means, or both the pendant control and the remote control may be provided.

Thus, there is shown and described a variable speed hoist that has the speed control integrated in the hoist body and the pendant controller.

Although other modifications and changes may be suggested by those skilled in the art, it is the intention of the inventors to embody within the patent warranted hereon all changes and modifications as reasonably and properly come within the scope of their contribution to the art.

I claim:

1. A hoist, comprising:
a housing;
a first connection on the housing for connection to a support;
a drive motor affixed to the housing;
motor control disposed within the housing and connected to control the drive motor speed, the motor control being operable to vary the operating speed of the motor;
a lifting medium wheel within the housing, the lifting medium wheel being connected to an output of the drive motor;
a lifting medium extending through the housing and engaging the lifting medium wheel, the lifting medium including a load connecting portion for engagement with a load; and
a user operable control device including an operable to provide a control signal to the motor control to thereby control the speed of movement of the lifting medium in a lifting medium movement direction.

2. A hoist as claimed in claim 1, wherein the motor control includes an inverter.

3. A hoist as claimed in claim 1, wherein the user operable control device includes one of a potentiometer, a digital controller, and a signal transmitted via a network.

4. A hoist as claimed in claim 1, wherein the user operable control device includes a pendant controller connected to the housing via a cable.

5. A hoist as claimed in claim 4, wherein the pendant controller includes an integrated control for receiving a user input of a variable speed control signal.

6. A hoist as claimed in claim 5, wherein the integrated variable speed control includes a rotatable knob integrated into a housing of the pendant controller, the rotatable knob operable to select from a plurality of possible operating speeds for varying at least one of the lifting and lowering speed of a load carried by the hoist.

7. A hoist as claimed in claim 1, wherein the motor is a three phase motor and wherein the motor control includes a variable frequency speed control signal connected to the three phase motor.

8. A hoist as claimed in claim 7, wherein control signal provided to the motor control is a voltage signal within a predetermined range of voltages, the voltage signal corresponding to a user selected operating speed of the hoist.

9. A hoist as claimed in claim 1, wherein the lifting medium is a length of chain, and wherein the lifting medium wheel is a chain wheel.

10. A hoist, comprising:
a hoist housing;
a motor within the hoist housing;
a housing support configured for support from a support structure;
an inverter within the hoist housing, the inverter having an output connected to the motor to provide a three-phase variable-frequency output signal to the motor, the inverter having a control input to receive a voltage signal within a predetermined voltage range;
a transmission within the housing and connected to the output of the motor;
a chain wheel in the housing and connected to an output of the transmission;
a chain mounted on the chain wheel; and
a remote control remote from the hoist housing and connected by a communication connection to the inverter and operable to provide a variable voltage signal to the inverter, the variable voltage signal correlating to a variable speed of operation of the hoist.

11. A hoist as claimed in claim 10, wherein the remote control is connected to the hoist housing by a cable.

12. A hoist as claimed in claim 10, wherein the remote control is a pendant control.

13. A hoist as claimed in claim 12, wherein the pendant control includes a potentiometer integrated into a housing of the pendant control, and a user operable control connected to operate the potentiometer.
